(19) United States
(12) Patent Application Publication
(10) Pub. No.: US 2026/0034029 A1
(43) Pub. Date: Feb. 5, 2026

(54) PILL DISPENSER

(71) Applicant: Xena Medical Technologies Inc., Milwaukee, WI (US)

(72) Inventors: Fadi A. Hussein, Brookfield, WI (US); Bashar A. Hussein, Lynnwood, WA (US)

(73) Assignee: Xena Medical Technologies Inc., Milwaukee, WI (US)

(21) Appl. No.: 19/288,137

(22) Filed: Aug. 1, 2025

Related U.S. Application Data
(60) Provisional application No. 63/679,301, filed on Aug. 5, 2024.

(51) Int. Cl. A61J 7/04

(52) U.S. Cl. CPC A61J 7/0436; A61J 7/0454; A61J 7/0481

(57) ABSTRACT

An automated pill dispenser is provided that include a housing having a first side and a second side, a processor and a conveyor assembly. The conveyor assembly includes a drive frame having a plurality of channels and a plurality of drive assemblies. Each of the plurality of drive assemblies include a row of pill cups between the first side and second side for receiving pills therein, a drive belt, a plurality of cup couplers individually coupling the row of pill cups to the drive belt, and a selectably actuatable motor rotatably coupled to a drive gear engaged with the drive belt, wherein actuation of the motor causes the row of pill cups to advance until one of the pill cups in the row of pill cups is vertically inverted from an upright position to an upside-down position as it traverses between the first side and second side of the housing.

### CROSS-REFERENCE TO RELATED APPLICATION

This application claims priority to U.S. Provisional Patent Appl. No. 63/679,301 filed on Aug. 5, 2024, the disclosure of which is incorporated herein by reference in its entirety for all purposes.

### FIELD OF THE INVENTION

The invention relates generally to dispensing devices and more particularly to pill dispensers.

### BACKGROUND OF THE INVENTION

Various medical illnesses require medications in the form of pills in order to treat the illness or manage the symptoms and in order to maintain patient well-being and avoid future complications. It is of great importance that patients adhere to a specific schedule of taking their medications. However, this has been proven by various clinical studies to be a daunting task due to forgetfulness, patients' busy lifestyle, or memory loss. For example, after an organ transplant it is vital that a patient maintain adherence to a medication schedule to avoid organ rejection or other complications.

Studies have shown that patients are nonadherent to their medicine 50% of the time. Approximately 117 million Americans live with at least one or more chronic diseases, often requiring multiple lifelong medications for control. Although various types of pill dispensers are known, they suffer from numerous deficiencies, including inoperability, difficult use, and unreliability due to poor design, and in many cases excessive cost. As such, there is a need for an improved pill dispenser.

### BRIEF SUMMARY OF THE INVENTION

In at least some embodiments, an automated pill dispenser is disclosed comprising: a housing having a front, a back, a first side, a second side, and bottom; a processor situated in the housing; and a conveyor assembly situated within the housing. The conveyor assembly comprising a drive frame having a plurality of channels; and a plurality of drive assemblies situated respectively in the plurality of channels. With each of the plurality of drive assemblies comprising: a row of pill cups positioned between the first side and second side of the housing for receiving pills therein; a drive belt; a plurality of cup couplers individually coupling the row of pill cups to the drive belt; and a selectably actuatable electrically powered motor at least indirectly in communication with the processor, and rotatably coupled to a drive gear engaged with the drive belt, wherein actuation of the motor causes the row of pill cups to advance until one of the pill cups in the row of pill cups is vertically inverted from an upright position to an upside-down position as it traverses between the first side and second side of the housing.

In at least some other embodiments, an automated pill dispenser is disclosed comprising: a housing having a front, a back, a first side, a second side, and bottom; a moveable tray coupled with the housing and having a plurality of pill receptacles; a conveyor assembly situated substantially within the housing, the conveyor assembly comprising: a drive frame having a plurality of channels, a plurality of upper rails, and a plurality of upper guide surfaces; a first drive assembly coupled to the drive frame and comprising: a plurality of first pill cups situated in a first row extending between the first side and second side of the housing; a first drive belt; a plurality of first cup couplers coupling the plurality of first pill cups to the first drive belt; and a first motor rotatably coupled to a first drive gear engaged with the first drive belt, wherein the first motor is selectably actuated to cause the first drive belt to rotate, thereby causing at least one of the plurality of first pill cups in the first row to advance towards a first pill receptacle of the plurality of pill receptacles; a second drive assembly coupled to the drive frame and situated in a second channel of the plurality of channels, and comprising: a plurality of second pill cups situated in a second row extending between the first side and second side of the housing; a second drive belt; a plurality of second cup couplers individually coupling the plurality of second pill cups to the second drive belt; and a second motor rotatably coupled to a second drive gear engaged with the second drive belt, wherein the second motor is selectably actuated to cause the second drive belt to rotate, thereby causing at least one of the plurality of second pill cups in the second row to advance towards a second pill receptacle of the plurality of pill receptacles; a third drive assembly coupled to the drive frame and situated in a third channel of the plurality of channels, and comprising: a plurality of third pill cups situated in a third row extending between the first side and second side of the housing; a third drive belt; a plurality of third cup couplers individually coupling the plurality of third pill cups to the third drive belt; and a third motor rotatably coupled to a third drive gear engaged with the third drive belt, wherein the third motor is selectably actuated to cause the third drive belt to rotate, thereby causing at least one of the plurality of third pill cups in the third row of pill cups to advance towards a third pill receptacle of the plurality of pill receptacles; a fourth drive assembly coupled to the drive frame and situated in a fourth channel of the plurality of channels, and comprising: a plurality of fourth pill cups situated in a fourth row extending between the first side and second side of the housing; a fourth drive belt; a plurality of fourth cup couplers individually coupling the plurality of fourth pill cups to the fourth drive belt; and a fourth motor rotatably coupled to a fourth drive gear engaged with the fourth drive belt, wherein the fourth motor is selectably actuated to cause the fourth drive belt to rotate, thereby causing at least one of the plurality of fourth pill cups in the fourth row to advance towards a fourth pill receptacle of the plurality of pill receptacles; and a processor-based control system electrically coupled with the first drive assembly, second drive assembly, third drive assembly, and fourth drive assembly, for receiving a user input and selectably actuating the first motor, the second motor, the third motor, or the fourth motor based at least in part on a time of day.

Other embodiments, aspects, and features of the invention will be understood and appreciated upon review of the figures and a reading of the detailed description and the claims that follow.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. In the drawings:

FIG. 1 is a front perspective view of an exemplary embodiment of a pill dispenser;

FIG. 2 is a rear perspective view of the pill dispenser of FIG. 1;

FIG. 3 is a front perspective view of the pill dispenser of FIG. 1 with the lid open;

FIG. 4 is a first-side perspective view of the pill dispenser of FIG. 1 with the lid open;

FIG. 5 is a partially exploded front perspective view of the pill dispenser of FIG. 1;

FIG. 6 is a partially exploded rear perspective view of the pill dispenser of FIG. 1;

FIG. 7 is a perspective cross-section view of the pill dispenser taken along lines 7-7 of FIG. 1;

FIG. 8 is front perspective view of a conveyor assembly of the pill dispenser of FIG. 1;

FIG. 9 is a bottom perspective view of the conveyor assembly of FIG. 8;

FIG. 10 is a front view of the conveyor assembly of FIG. 8;

FIG. 11 is a bottom view of the conveyor assembly of FIG. 8;

FIG. 12 is top perspective view of a drive frame of the conveyor assembly of FIG. 8;

FIG. 13 is first-side perspective view of the drive frame of FIG. 12;

FIG. 14 is a top view of the drive frame of FIG. 12;

FIG. 15 is bottom perspective view of the drive frame of FIG. 12;

FIG. 16 is first-side view of the drive frame of FIG. 12;

FIG. 17 is second-side perspective view of the drive frame of FIG. 12;

FIG. 18 is first-side perspective view of a subframe of the drive frame of FIG. 12;

FIG. 19 is first-side perspective view of the subframe FIG. 18;

FIG. 20 is a first-side view of the subframe of FIG. 18;

FIG. 21 is a second-side perspective view of a primary guide block of the drive frame of FIG. 12;

FIG. 22 is bottom perspective view of the primary guide block of FIG. 21;

FIG. 23 is a second-side perspective view of a secondary guide block of the drive frame of FIG. 12;

FIG. 24 is front perspective view of the secondary guide block of FIG. 23;

FIG. 25 is a side perspective view of a cup coupler of the pill dispenser of FIG. 1;

FIG. 26 is a bottom perspective view of the cup coupler of FIG. 25;

FIG. 27 is a rear perspective view of a drive assembly of the conveyor assembly of FIG. 8;

FIG. 28 is a bottom perspective view of the drive assembly of FIG. 27;

FIG. 29 is a first-side perspective partial view of the conveyor assembly of FIG. 8, with each row shown in a different state of assembly for illustrative purposes;

FIG. 30 is a second-side perspective view of the conveyor assembly of FIG. 29;

FIG. 31 is a top view of the conveyor assembly of FIG. 29;

FIG. 32 is a bottom view of the conveyor assembly of FIG. 29;

FIG. 33 is front perspective view of a tray assembly of the pill dispenser of FIG. 1;

FIG. 34 is bottom perspective view of the tray assembly of FIG. 33;

FIG. 35 is an exploded front perspective view of the tray assembly of FIG. 33;

FIG. 36 is block diagram of a control system of the pill dispenser of FIG. 1;

FIG. 37 is an exploded view of an exemplary pill dispenser attachment for use with the pill dispenser of FIG. 1;

FIG. 38 is front perspective view of the exemplary pill dispenser attachment of FIG. 1 with the cover removed; and

FIG. 39 is bottom perspective view of the pill dispenser attachment of FIG. 38 with the cover removed.

### DETAILED DESCRIPTION

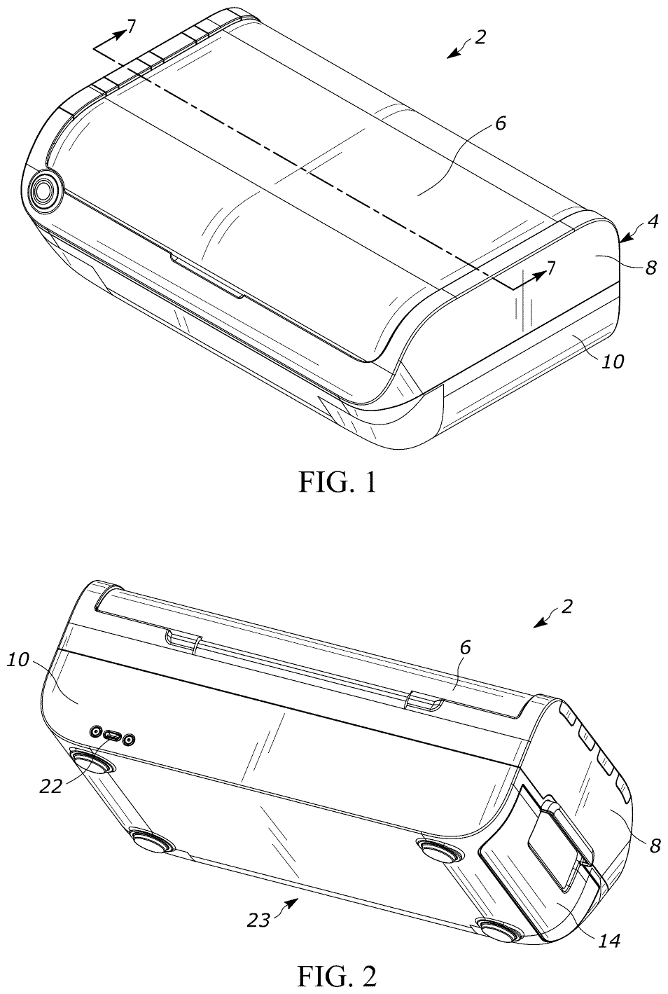

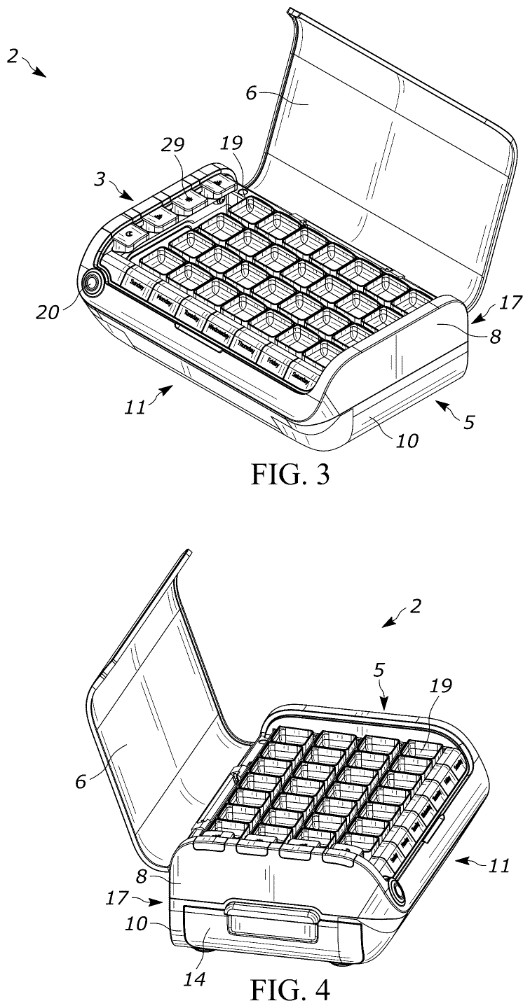

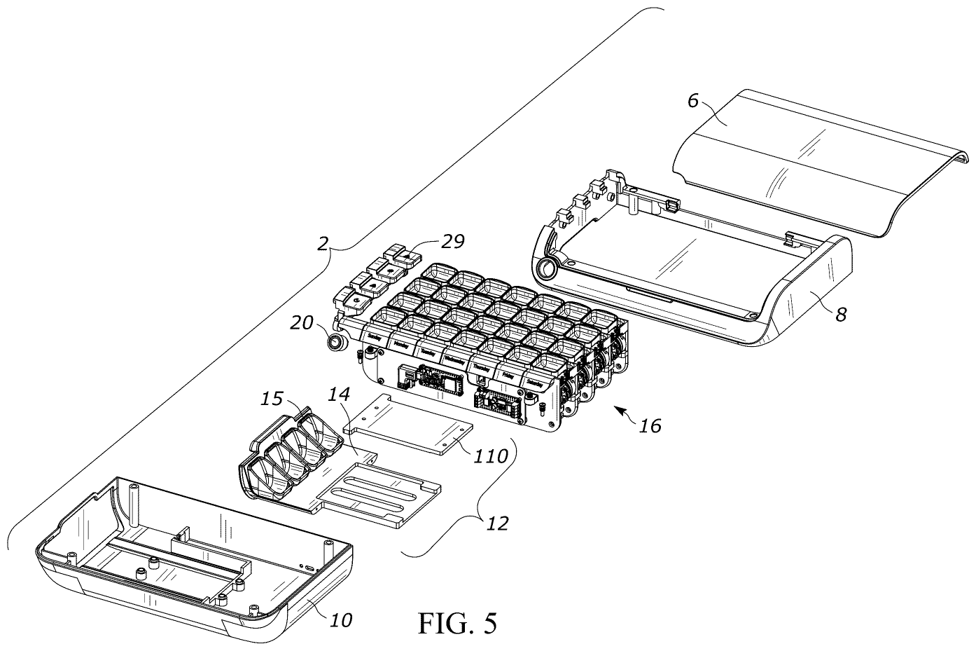

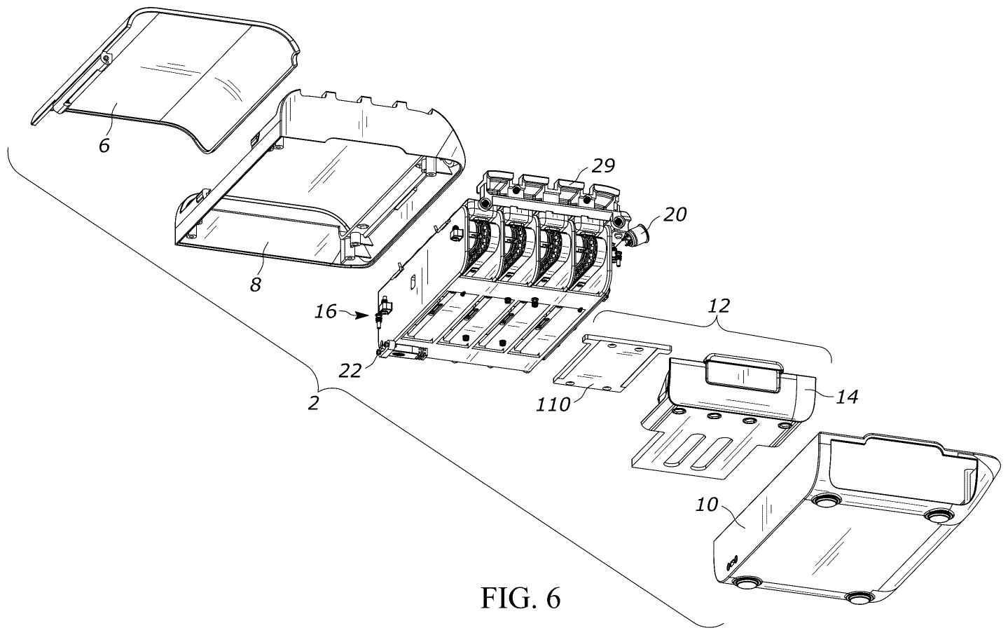

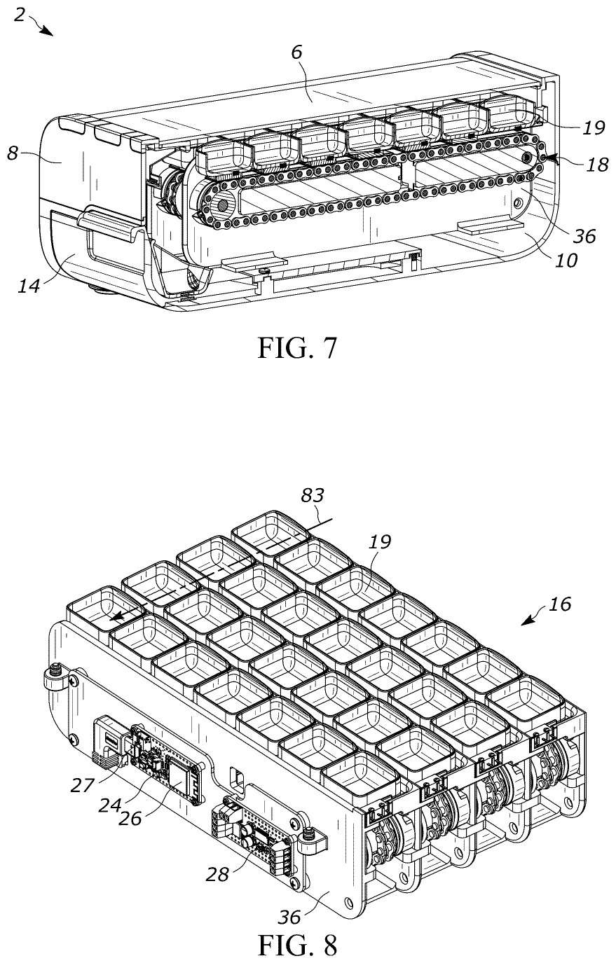

Referring to FIGS. 1 and 2, an exemplary embodiment of a pill dispenser 2 is provided. The pill dispenser includes a housing 4 having a lid 6, where in at least some embodiments, the housing 4 includes an upper portion 8 and a lower portion 10, although other housing configurations can be utilized. FIGS. 3 and 4 illustrate the pill dispenser 2 with the lid 6 open and the housing having a first side 3, a second side 5, a front 11, a back 17, and a bottom 23 (FIG. 2). A tray assembly 12 is also included with a moveable tray 14 to catch dispensed items (e.g. pills) in a plurality of pill receptacles 15, which can be coupled magnetically (e.g., magnets 13) or otherwise to the tray 14, so that a user can easily retrieve them. FIGS. 5 and 6 provide partially exploded perspective views of the pill dispenser 2 of FIG. 1, and FIG. 7 provides a perspective cross-section view taken along lines 7-7 of FIG. 1.

The pill dispenser 2 includes various components to facilitate operation and communication as desired. Such components can include a pill dispense button 20, wherein a user can push the button to activate the dispensing of select pills, as well as various other components that may be shown or otherwise understood to be included to provide the described functionality herein. The pill dispenser 2 is configured to dispense pills on a scheduled or on-demand basis using a conveyor assembly 16 that includes various drive assemblies 18, with each drive assembly 18 forming a row of pill cups 19 in the pill dispenser 2, for example, four rows to accommodate four different times of the day for pills to be taken. Each row of pill cups 19 can also be further labeled on the pill dispenser with a time of day insert 29, or other markings, such that a user looking down on the top of the pill dispenser with the lid open can identify which pill cup correlates with a specific time of day. In addition, the drive assemblies 18 extend between the first side 3 and second side 5 and parallel to each other to form the rows. This aligns the pill cups 19 in columns, where each column can represent a day of the week (e.g., seven columns), for example, providing a matrix of pill cups 19 that can provide a single week of pills to be dispensed at up to four different times. Although in at least some embodiments, the pill dispenser can be designed in different ways to allow for variations of medication schedules and allowing for longer durations before the next refill by adding more or less drive assemblies 18, as well as more pill cups in each drive assembly 18.

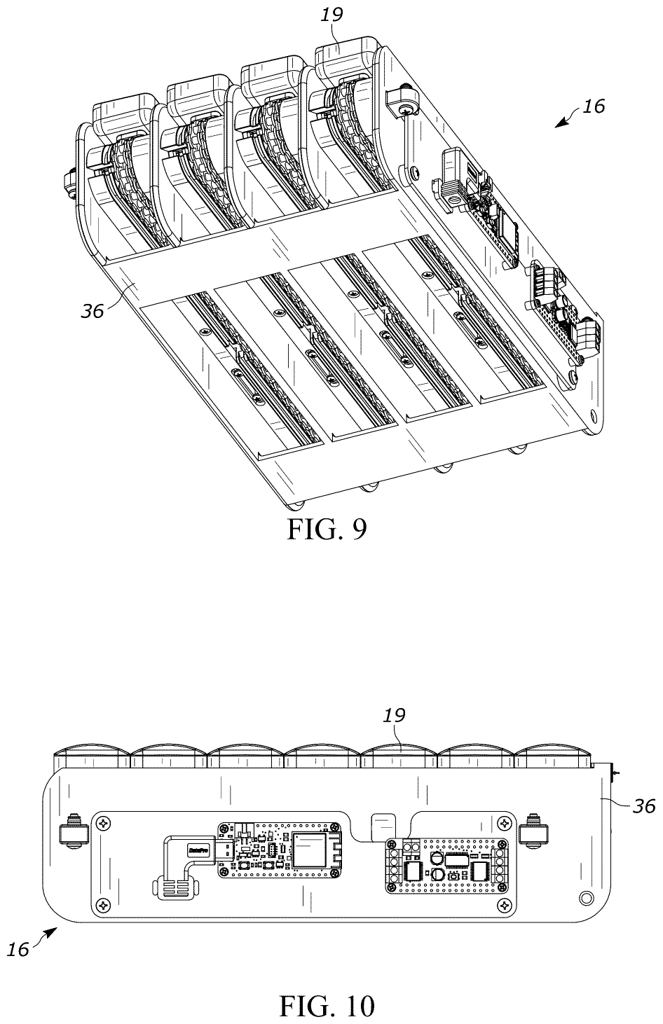

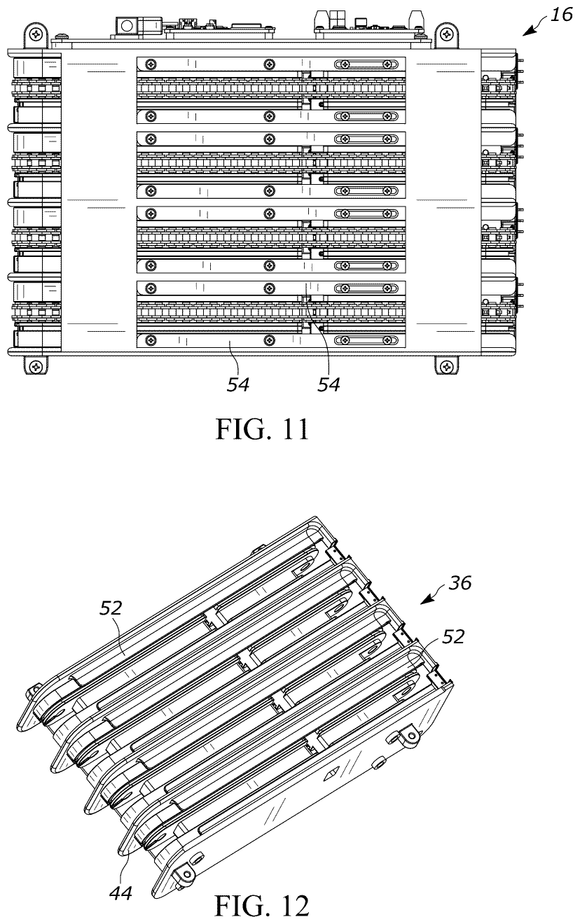

FIGS. 8-11 illustrate various views of the conveyor assembly 16 that includes the drive assemblies 18. In at least some embodiments, the drive assemblies 18 are configured to be activated by a control system 21. The control system 21 provides control and communication for the pill dispenser 2 and in at least some embodiments can include a processor 26 and a power management circuit (e.g., circuit 27) to receive, send, convert, and regulate power as needed, although other components can be included as desired or necessary to provide the functionality described herein, as well as other desired functionality using known or unknown methods. Power for the pill dispenser can be provided in various manners, for example in at least some embodiments a rechargeable DC battery (not shown) inside the housing 4 is coupled to the control system 21, with a charging power input port (not shown) on the housing provided to recharge the battery. In other embodiments, other sources of power can be utilized such as a 120 VAC cord and an AC/DC converter to deliver power to the power management circuit through a power plug input port 22 (as shown).

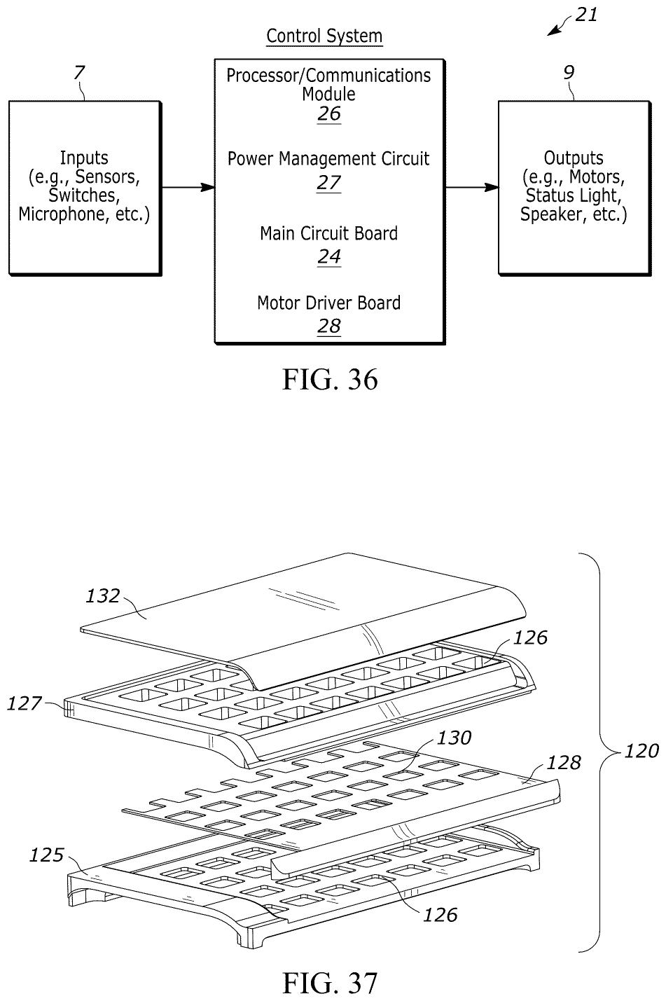

The control system 21 is in communication with various pill dispenser inputs 7 and outputs 9, and in some embodiments, one or more communication devices (e.g. ethernet Bluetooth, WIFI, cellular, NFC, etc.) are provided in communication with the processor 26. The control system 21 is comprised of several circuit components, mounted in various locations about the pill dispenser 2, which are configured to sense inputs, such as activation commands, limit switch activation, pushbuttons, optical sensors, etc., and provide outputs to other devices, such as motor activation, visual or audible annunciations, etc. In at least some embodiments (see FIG. 8 and FIG. 36), the control system 21 includes one or more circuit boards including a main circuit board 24 with the processor 26 configured to provide communications with various internal and external devices. External devices can include smart device, database, etc. and additional communication modules can be included for Bluetooth, WIFI, cellular, etc. The main circuit board 24 is configured to control the operation of various motors, and includes various sensors, such as pill drop position sensors 96, limit switches 94, as well as a motor driver circuit board (e.g., circuit board 28), a power management circuit, etc. Such components can be situated on any number of circuit boards and in various mounting locations, and can be discreet or integral components, therefore the exemplary illustrated configurations shall not be considered limiting.

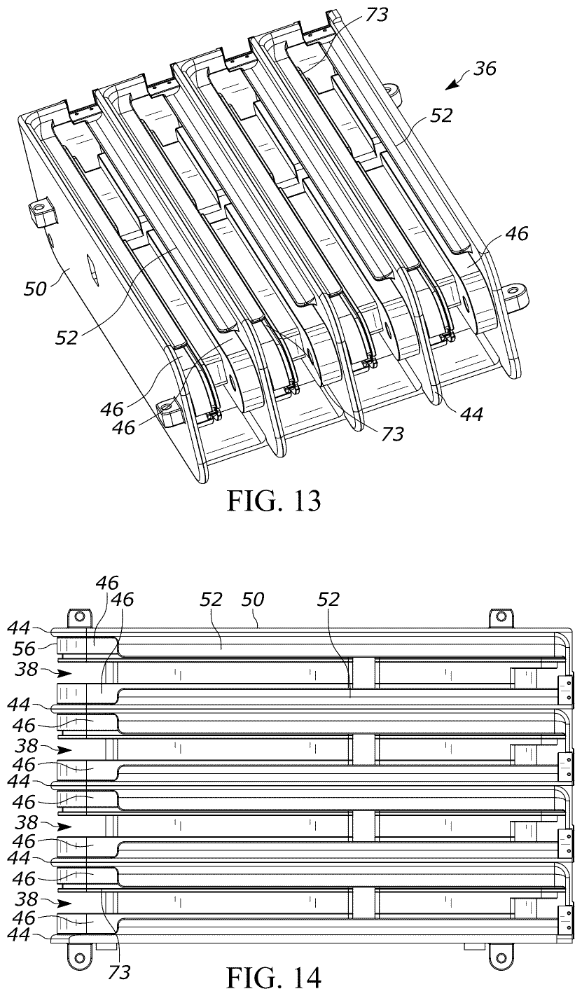

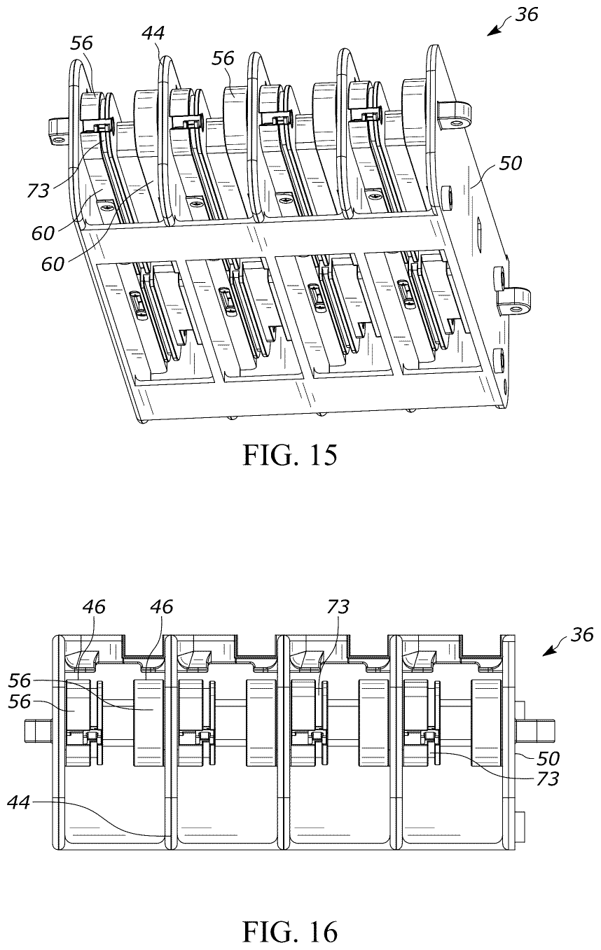

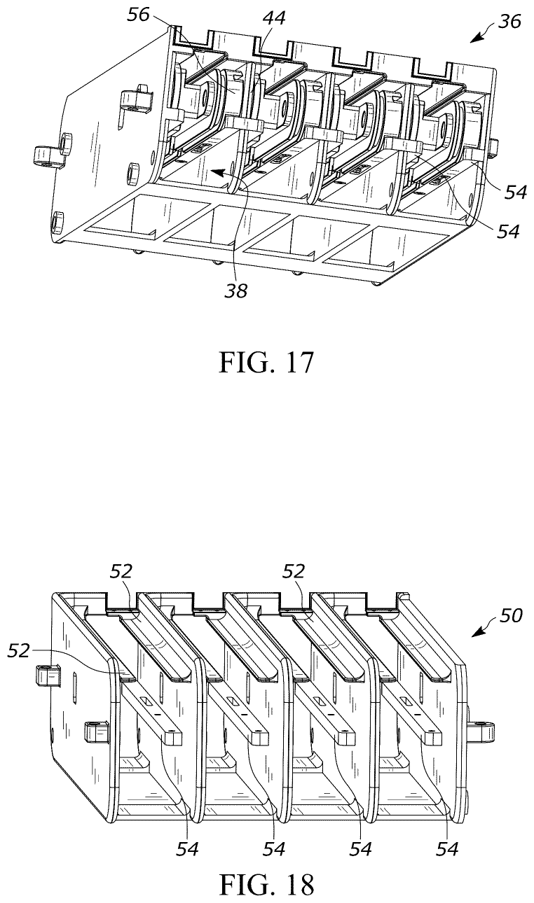

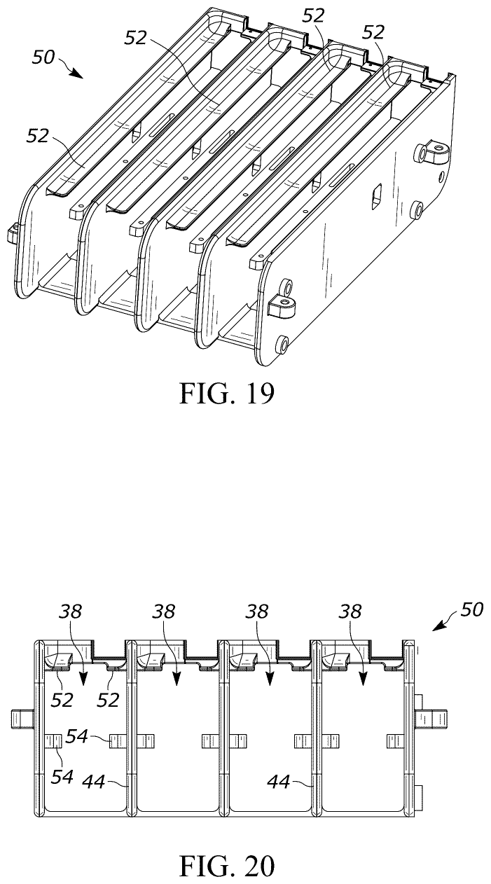

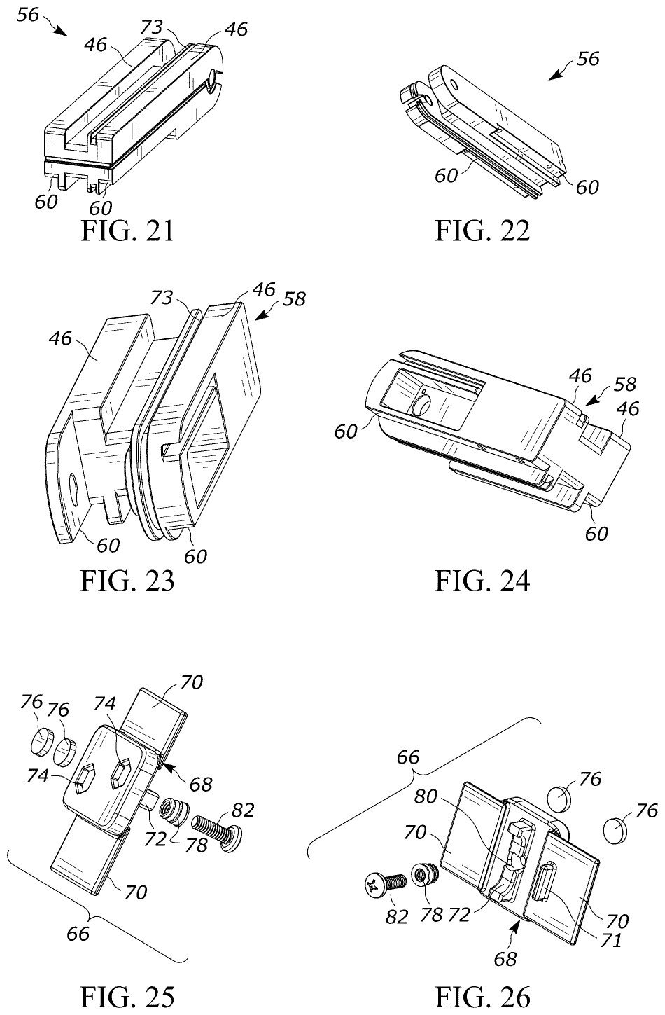

The conveyor assembly 16 includes a drive frame 36 as shown in exemplary FIGS. 12-17 in various views. The drive frame 36 can take many forms to accommodate variations in the drive assemblies 18, etc., although in at least some embodiments, the drive frame 36 includes a plurality of channels 38 situated between frame walls 44 extending longitudinally between first and second sides of the pill dispenser 2 and parallel to each other. The drive frame can further include guides in each channel 38 having upper guide surfaces 46, which can take many forms to support the drive assemblies 18. In at least some embodiments, the drive frame 36 can be comprised of a single component or a plurality of components manufactured separately and assembled to provide the desired functionality. For example, such as seen in FIGS. 18-24, the drive frame 36 can include a subframe 50 (FIGS. 18-20) that includes and connects the frame walls 44. The subframe 50 can also include upper rails 52 and side rails 54, each formed with or secured to the frame walls 44, and which protrude perpendicularly into the channels 38. In at least some embodiments, secured to the side rails 54 in each channel 38 are a primary guide block 56 (FIGS. 21 and 22) and a secondary guide block 58 (FIGS. 23 and 24). The guide blocks can include longitudinally extending lower guide surfaces 60 on the bottom configured to rest on and be secured to the side rails 54, although other methods of coupling to the subframe 50 can be utilized. In such an embodiment, the upper guide surfaces 46 can be provided on the guide blocks 56, 58. In addition, the guide blocks can provide structure for the drive assemblies 18 to be mounted, as discussed below.

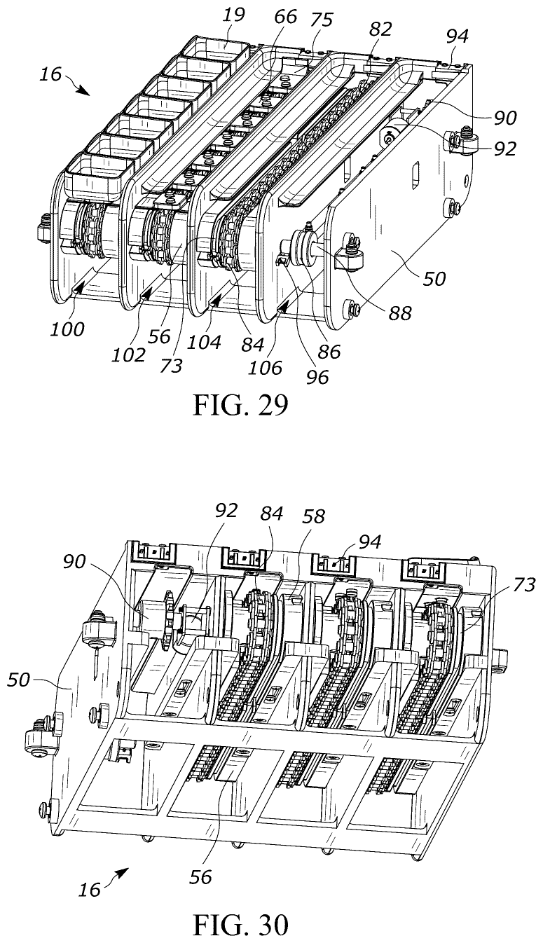

The pill cups 19 provided in each of the rows in the conveyor assembly 16 can be coupled to the drive assemblies 18 using various methods. In at least some embodiments, the pill cups 19 are removably coupled to a drive assembly 18 using a cup coupler 66 (see FIGS. 25 and 26), which in some embodiments can include: a coupler base 68 having a pair of planar side wings 70, a chain engagement protrusion 72, coupler magnet receptacles 74, coupler magnets 76, a threaded engagement nut 78 configured to engage an opening 80, and a chain screw 82 configured to threadably engage the threaded engagement nut 78. The coupler magnets 76 are attracted to metal elements (or magnets) secured about the bottom of the pill cup 19. This provides a temporary engagement of each pill receptacle to allow a user to remove the pill cup 19 from the pill dispenser 2 if desired to fill or empty out the contents. The side wings 70 are configured to glide along and between the upper guide surfaces 46 and the upper rails 52 and can include a downward facing tab 71 that rides in tracks 73 in the drive frame 36 to assist with keeping the pill cups 19 in position. In at least some embodiments, these tracks 73 are formed in each of the guide blocks 56, 58. In at least some embodiments, the last coupler base in each row can be extended to include an upwards sloping lip 75 (see FIG. 29). The lip 75 serves to assist with abutting the pill cups 19 and can be used as the trigger for the limit switch 94.

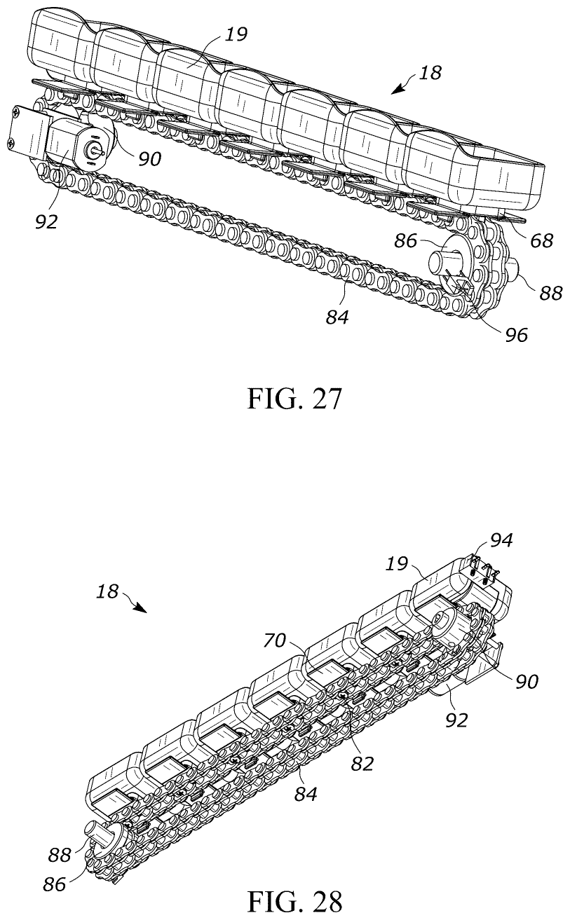

Referring now to FIGS. 27 and 28, exemplary perspective views are provided of the drive assembly 18 for a single row in the conveyor assembly 16. In at least some embodiments, the drive assembly 18 includes a drive belt 84 that extends between a spool 86 (rotatably secured by an axle 88 that is secured to the drive frame 36, for example by opposing apertures in the secondary guide block 58, and a drive gear 90 rotated by a known driveshaft coupling (e.g., geared driveshafts meshed at a 90 degree angle, etc.) via a motor 92. Other drive configurations can be utilized to provide the same or similar functionality.

The motor 92 is selectably energized by the control system 21 to rotate the drive gear 90 and drive belt 84 to advance the row of pill cups 19 towards the pill receptacles 15 when the contents (e.g., pills) of the end pill cup 19 (i.e., the upright pill cup 19 closest to the first side 3) from that row is desired to be dispensed into a pill receptacle 15 for retrieval by the user. The drive assemblies 18 can each further include a limit switch 94 mounted at one end of the channel 38 for sensing pill cup 19 positioning; and a pill drop position sensor 96 (e.g., optical sensor, laser sensor, etc.) situated at the opposite end (e.g., adjacent a dispensing end of each drive assembly 18). The pill drop position sensor 96 for each specific drive assembly is positioned to sense a pill cup 19 reaching a “drop position” (where the pill cup 19 has been inverted from an upright position to an upside-down position) to indicate that contents of the pill cup 19 should have been dispensed as the cup is now facing downwards. The tab 71 on the bottom of the side wing 70 can be used as the trigger for the pill drop position sensor 96, which is coupled to the control system 21 to provide a feedback signal for a specific drive assembly. Other sensors and locations can be utilized to provide the control system 21 desired feedback on the actions and positions of various components. Further, in at least some embodiments, a torque limiter can be coupled to each drive belt to prevent damage to the components along with a tensioner for each drive belt. It shall be understood that the drive belt can take many forms, such as a plastic or metal linked chain (as shown herein), as well as a ribbed rubber component, etc.

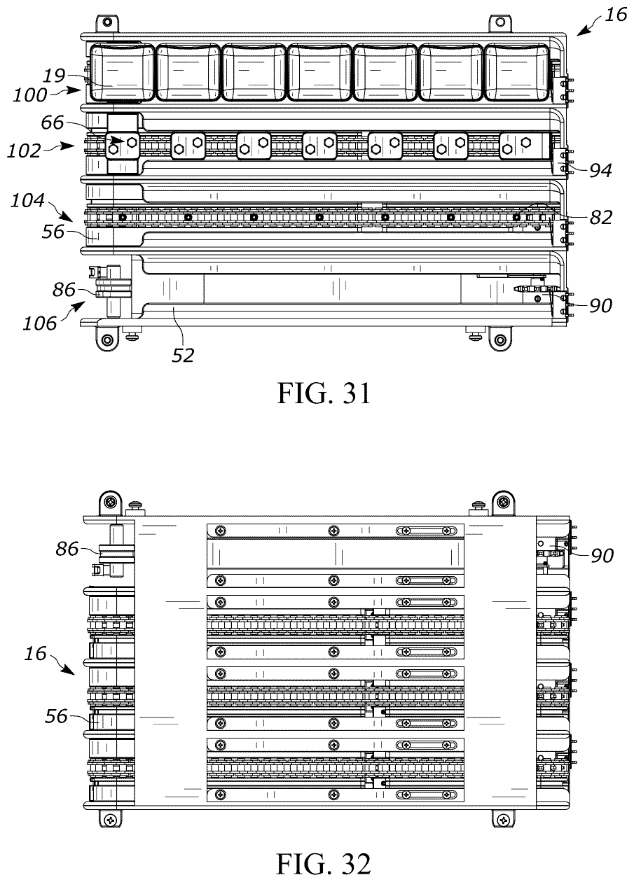

Referring now to FIGS. 29-32, for illustrative purposes the conveyor assembly 16 is shown with each row in different states of assembly. While row 100 has no components removed, row 102 is shown with the pill cups 19 removed to expose the cup couplers 66 for each of the pill cups 19. Row 104 further removes the cup coupler 66, but leaves the chain screws 82 extending upwards vertically through the links in the drive belt 84 to engage the threaded engagement nut 78 of the cup coupler 66. Finally, row 106, further removes the drive belt 84 and the primary guide block 56 and secondary guide block 58.

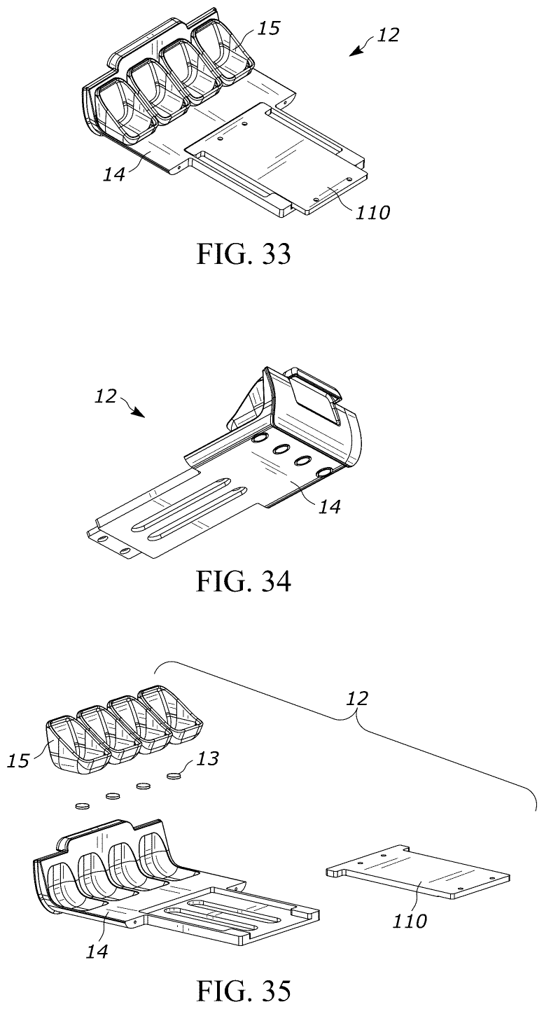

Referring to FIGS. 33-35, the tray assembly 12 is shown in greater detail in various views. The tray assembly 12 further includes a tray mount 110 that is secured to the lower portion 10 of the housing to allow a user to slide the tray 14 outwards and retrieve pills dispensed into the pill receptacles 15. In addition, the pill receptacles 15 can be magnetically coupled to the tray 14 using magnets 13 to selectably secure their position, but still allow a user to remove them to dump the contents out.

The pill dispenser 2 can function in numerous ways. In at least some embodiments, the control system 21 is aware of at least the time of day and day of the week (via the processor, onboard internal memory, and/or time updates obtained from an internet connection, etc.) and when it receives an input signal from the pill dispense button 20 (user pushes the button) to dispense one or more pills it checks the time and day, and the pre-programmed and/or currently updated instructions to ascertain which rows(s) of pill cups (i.e., which drive assembly) should be advanced by activating the motor to dispense the appropriate one or more pills from the coupled pill cup(s) situated in a first column 83 (FIG. 8) of the matrix. Such programming or instructions can be instituted in various manners, such as during manufacturing, via the aforementioned application, a user touchscreen interface (if provided), and/or another application in communication with the pill dispenser 2. Additional or specific for taking action based on the day, time, and button actuation, can also be updated, programmed, stored, or otherwise communicated to the processor using these same methods. Returning to the function of the pill dispenser, after determining which drive assembly motor(s) should be energized, the control system 21 sends power to the motor 92 in the appropriate drive assembly to advance the drive belt 84 to move the coupled pill cup 19 forward until it is upside-down causing the pills therein to drop into the pill receptacle 15 situated below the pill cup 19, with the limit switch 94 detecting the position of the pill cup 19 and sending a signal to the control system 21 indicating when sufficient advancement of the drive belt 84 has occurred, wherein the control system then stops sending power to the motor. Either subsequently or concurrently, each drive assembly is activated to dispense other pills situated in the other columns. For example, if a user is taking two different pills on a given day and time, which have been loaded into the pill cups of two different drive assemblies, then when the user pushes the pill dispense button, the control system activates (based on programmed or updated instructions) those two drive assemblies to dispense the pills therein. In other embodiments, when the user pushes the pill dispense button, the control system can simply activate all the drive assemblies 18 at once, regardless of whether they contain a pill, thereby advancing all the pill cups 19 situated in the first column 83 at once.

In at least some embodiments, the pill dispenser 2 can include additional components, such as an attached table lamp (reading lamp) and a charging port for mobile device, such as phones and smart watches. In at least some embodiments, the pill dispenser can be equipped with an optional camera and facial recognition software to identify users and record them taking the pills if deemed clinically necessary, and/or a camera with pill recognition capability to ensure the correct pills were dispensed. In at least some embodiments, the pill dispenser can include an interface display (e.g. LCD display, etc.) in communication with the control system 21 and secured to the housing to provide information to the user, or to receive touch-based inputs from the user.

In at least some embodiments, the control system 21 of the pill dispenser 2 can be in communication with another device (e.g., mobile phone, computer, tablet, etc.). In some embodiments, a pill dispenser interface application (“the application”) can be installed on or accessed by the device to communicably interface with the pill dispenser and provide various graphical and/or auditory communications/notifications to a user. The application and/or the pill dispenser itself, can be in communication with yet other devices, such as home monitoring devices, or networks associated with pharmacies, medical providers, insurance providers, dieticians, relatives of the user, etc. In at least some embodiments, the application is configured to perform one or more of the following: show future user appointments including clinic and lab visits; connect to the pill dispenser wirelessly (e.g., cellular, Bluetooth or Wi-Fi, etc.) to send and receive information; connect to home monitoring devices; send a regularly scheduled questionnaire to the user to help identify side effects and encourage user compliance; display photos of the prescribed pills to help the user when refilling the pill dispenser and also for identifying and learning about their pills; medications added to the application will trigger a search for potential interactions and alert the user and a healthcare provider about any serious interactions; assist a user with identifying cheaper options for their medications or cheaper pharmacies; display illustrations to help a user fill the pill dispenser correctly and/or to assist the user with setting up the pill dispenser in different configurations depending on specific needs. In at least some embodiments, the application can communicate to the control system 21 which pills (i.e., pill cups) are to be dispensed on which days and which times via activation of the appropriate drive assembly 18.

In addition to the above, various other communications, operations, etc. can be configured to operate with the pill dispenser. For example: the pill dispenser can function as a central hub connecting by Bluetooth to other devices that measure heart rate, blood pressure, temperature, pulse oximetry, exercise, sleep and wake times, glucose levels, weight scale, water intake (Bluetooth water bottle), or urine output; the pill dispenser can send alerts to the user to hold or take out one of the pills from a pill cup if a health parameter received by a medical provider or connected device suggest that it would be detrimental to user's health to do so. Using an AI (artificial intelligence program) with machine learning; the AI program can gain access to the user's lab results and this will allow it to send alarms to avoid certain pills that need to be held according to a medical algorithm and user's own pre-set parameters, for example, if the potassium was too high then send an alarm to stop potassium supplements; all or part of the necessary data (pill information, health parameters, medical directives, what time pills were dispensed, which pills were dispensed, etc.) can saved in a cloud-based network, which can then be monitored and viewed remotely by the medical provider or a user's caregiver for example; the AI program and Machine learning program can also learn to adapt to a user's lifestyle and sleep wake cycle and adjust pill administration times to allow for better user compliance, and remind users to dispense pills early in the day so they transport the pills with them in case they are expected to come home late (after the scheduled medication time); also through AI and Machine learning the pill dispenser is able to communicate with pharmacies and request medication refills on time and decline refills if pills were not used as anticipated and if there is still a remaining quantity that does not call for refills. It can also help synchronize pill refills to minimize trips to a pharmacy; the AI program can also search for drug interactions and common side effects to alert users, caregivers and pharmacies of these interactions and any side effects when they appear; the pill dispenser can have an alarm function that communicates with personal assistants like Siri, Alexa, and Google, and connects to the calendar function on the device (e.g., mobile phone) running the application to alert user to dispense pills early in case they are staying out late that day beyond the schedule time to take their pills, and then carry those pills in a special case and the application will alert them on the device when the time comes to take the pills; AI software can push educational material and alerts to the device to avoid certain foods that can interact with the pills, and send reminders on the importance of taking pills on time, and link any changes in the health parameters mentioned above to missed pills; the application can send a daily questionnaire to the user regarding potential side effects and complications related to recent surgeries or interventions; the application can send reminders regarding doctor visits, lab appointments, procedures, and surgeries and remind user stop certain pills before surgery as indicated by their medical provider; the application can show the images of the pills that are scheduled to be taken so the user can have a visual confirmation of the correct pills to be taken; the device can send information to a cloud service, which can be accessed by the health care team to monitor patient compliance and progress and their related vital signs and other parameters as indicated by their medical condition; the pill dispensing device 2 and any patient home monitoring system can be configured to optimize patient care and enhance and monitor medication compliance and connect with other devices that monitor vital signs and connect with patient's medical chart to allow the medical provider to monitor patient compliance and adjust medication doses or hold certain medications if clinically indicated; and the pill dispenser and/or application can be linked to artificial intelligence software with machine learning that is individualized to each user and serves as an early detection method to avoid medication administration errors or medication interactions, such an AI program can also learn patient sleep cycle, work schedule and daily activities, and schedule and automatically adjust medication administration times accordingly and avoid missed doses. In addition, patient data including their medication administration history and vital signs can be analyzed using an artificial intelligence (AI) program that is individualized for each patient and learns about each patient situation individually and independently to help predict future actions based on new situations. A patient's use of the pill dispenser can assist with this by recording and communicating actual compliance, for example, among other things.

Referring now to FIG. 37, an exemplary optional pill dispenser attachment 120 for the pill dispenser is shown in an exploded view. The pill dispenser attachment 120 includes an attachment frame 124 having a bottom portion 125 and a top portion 127, with a plurality of aligned pill passages 126 extending through both portions. A removable tray panel 128 is coupled with the attachment frame 124 and provides a temporary barrier to the pill passages 126 in a first tray position, and a pass-through in a second tray position. More particularly, the tray panel 128 includes an array of cutouts 130 therethrough that can be movably aligned with the pill passages 126 by pulling the tray panel 128 outwards.

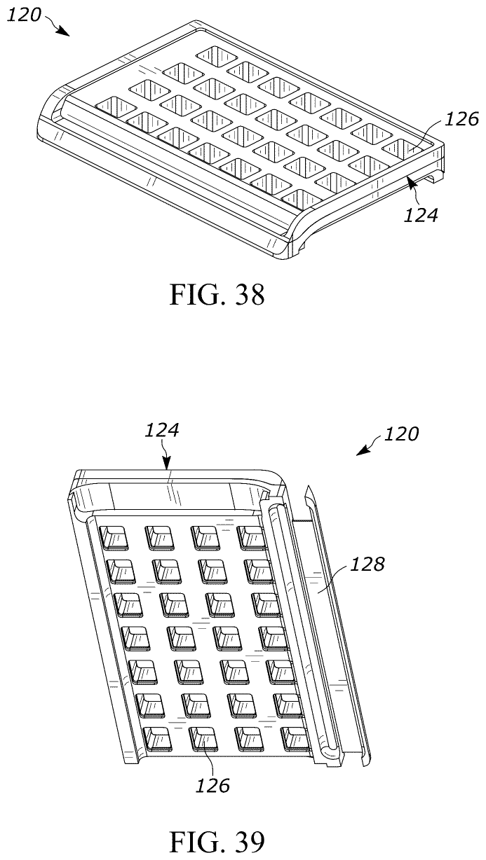

The pill dispenser attachment 120 can be prefilled with pills and then placed on top of the pill dispenser (lid open). The tray panel 128 is then pulled outwards a short distance, aligning the cutouts 130 with the pill passages 126 to allow the pills to drop through the now open pill passages 126 and into the pill cups 19 situated directly below, thereby “loading” the pill dispenser 2 for use by a user and avoiding the task of filling each pill cup 19 individually. A removable cover 132 can be provided to cover pills in their pill passages 126. FIG. 38 provides a front perspective view of the pill dispenser attachment 120 with no cover, and FIG. 39 shows a bottom perspective view with the tray panel 128 moved outwards to align the cutouts 130 with the pill passages 126.

The term “pill” is to be broadly construed to encompass various consumable objects, such as vitamins, supplements, and medications; and shall include various forms, such as tablets, capsules, etc. Although the invention has been herein described in what is perceived to be the most practical and preferred embodiments, it is to be understood that the invention is not intended to be limited to the specific embodiments set forth above but include modified forms of those embodiments including portions of the embodiments and combinations of elements of different embodiments as come within the scope of the following claims. Further, it is recognized that modifications may be made by one of skill in the art of the invention without departing from the spirit or intent of the invention and, therefore, the invention is to be taken as including all reasonable equivalents to the subject matter of the appended claims and the description of the invention herein. And, although certain advantages of different embodiments and disadvantages of certain prior art are described, no single claim must realize every or any benefit or overcome every or any disadvantage. The term “plurality” as used herein shall be understood to include one or more. The term “coupled” as used herein shall be understood to include electrical or mechanical connections as appropriate.

We claim:

1. An automated pill dispenser comprising:
a housing having a front, a back, a first side, a second side, and bottom;
a processor situated in the housing; and
a conveyor assembly situated within the housing, the conveyor assembly comprising:
a drive frame having a plurality of channels; and
a plurality of drive assemblies situated respectively in the plurality of channels, each of the plurality of drive assemblies comprising:
a row of pill cups positioned between the first side and second side of the housing for receiving pills therein;
a drive belt;
a plurality of cup couplers individually coupling the row of pill cups to the drive belt; and
a selectably actuatable electrically powered motor at least indirectly in communication with the processor, and rotatably coupled to a drive gear engaged with the drive belt, wherein actuation of the motor causes the row of pill cups to advance until one of the pill cups in the row of pill cups is vertically inverted from an upright position to an upside-down position as it traverses between the first side and second side of the housing.

2. The automated pill dispenser of claim 1, wherein the plurality of drive assemblies includes:
a first drive assembly coupled to the drive frame and situated in a first channel of the plurality of channels, and comprising:
a first row of pill cups positioned between the first side and second side of the housing for receiving pills therein;
a first drive belt;
a plurality of first cup couplers individually coupling the first row of pill cups to the first drive belt; and
a selectably actuatable electrically powered first motor at least indirectly in communication with the processor, and rotatably coupled to a first drive gear engaged with the first drive belt, wherein actuation of the first motor causes the first row of pill cups to advance until one of the pill cups in the first row of pill cups is vertically inverted from an upright position to an upside-down position as it traverses between the first side and second side of the housing; and
a second drive assembly coupled to the drive frame and situated in a second channel of the plurality of channels, and comprising:
a second row of pill cups positioned between the first side and second side of the housing;
a second drive belt;
a plurality of second cup couplers individually coupling the second row of pill cups to the second drive belt; and
a selectably actuatable electrically powered second motor at least indirectly in communication with the processor, and rotatably coupled to a second drive gear engaged with the second drive belt, wherein actuation of the second motor causes the second row of pill cups to advance until one of the pill cups in the second row of pill cups is vertically inverted from an upright position to an upside-down position as it traverses between the first side and second side of the housing.

3. The automated pill dispenser of claim 2, wherein the plurality of drive assemblies further includes a third drive assembly coupled to the drive frame and situated in a third channel of the plurality of channels, and comprising:
a third row of pill cups positioned between the first side and second side of the housing;
a third drive belt;
a plurality of third cup couplers individually coupling the third row of pill cups to the third drive belt; and
a selectably actuatable electrically powered third motor at least indirectly in communication with the processor, and rotatably coupled to a third drive gear engaged with the third drive belt, wherein actuation of the third motor causes the third row of pill cups to advance until one of the pill cups in the third row of pill cups is vertically inverted from an upright position to an upside-down position as it traverses between the first side and second side of the housing.

4. The automated pill dispenser of claim 3, wherein the plurality of drive assemblies further includes a fourth drive assembly coupled to the drive frame and situated in a fourth channel of the plurality of channels, and comprising:
a fourth row of pill cups positioned between the first side and second side of the housing;
a fourth drive belt;
a plurality of fourth cup couplers individually coupling the fourth row of pill cups to the fourth drive belt; and
a selectably actuatable electrically powered fourth motor at least indirectly in communication with the processor, and rotatably coupled to a fourth drive gear engaged with the fourth drive belt, wherein actuation of the fourth motor causes the fourth row of pill cups to advance until one of the pill cups in the fourth row of pill cups is vertically inverted from an upright position to an upside-down position as it traverses between the first side and second side of the housing.

5. The automated pill dispenser of claim 4, further comprising a control system that includes the processor and is coupled with the first drive assembly, the second drive assembly, the third drive assembly, and the fourth drive assembly, for receiving a user input and selectably actuating the first motor, the second motor, the third motor, or the fourth motor based at least in part on a time of day.

6. The automated pill dispenser of claim 5, wherein the control system further includes:
a main circuit board;
a motor driver;
a power management circuit;
a pill dispense button;
a plurality of limit switches; and
a plurality of pill drop position sensors.

7. The automated pill dispenser of claim 4, wherein the drive frame further includes a plurality of frame walls extending longitudinally between the first side and second side of the housing and at least partially separating from each other the first channel, the second channel, the third channel, and the fourth channel.

8. The automated pill dispenser of claim 7, wherein the drive frame further comprises a plurality of longitudinal upper guide surfaces and a plurality of upper rails in each of the plurality of channels, for guiding the plurality of first cup couplers, the plurality of second cup couplers, the plurality of third cup couplers, and the plurality of fourth cup couplers as they traverse between the first side and second side of the housing.

9. The automated pill dispenser of claim 8, wherein each of the plurality of first cup couplers, the plurality of second cup couplers, the plurality of third cup couplers, and the plurality of fourth cup couplers include a respective coupler base having a pair of planar side wings.

10. The automated pill dispenser of claim 9, wherein the drive frame includes a plurality of side rails protruding horizontally from the plurality of frame walls.

11. The automated pill dispenser of claim 10, wherein the drive frame further includes primary guide blocks and secondary guide blocks secured to the plurality of side rails in each of the first channel, the second channel, the third channel, and the fourth channel.

12. The automated pill dispenser of claim 4, further comprising a first pill receptacle removably situated at the first side of the housing for receiving pills dispensed from the first row of pill cups.

13. The automated pill dispenser of claim 5, further comprising a rechargeable battery coupled to the control system.

14. The automated pill dispenser of claim 4, further comprising a pill dispenser attachment comprising:
an attachment frame having a top portion along with a bottom portion that is shaped for placement over the upper portion of the housing, with the attachment frame also having a plurality of aligned pill passages extending through both the top portion and the bottom portion; and
a removable tray panel having an array of cutouts therethrough, and movably situated between the top portion and the bottom portion to provide a removable barrier to the pill passages in a first tray position, and a pass-through in a second tray position.

15. An automated pill dispenser comprising:
a housing having a front, a back, a first side, a second side, and bottom;
a moveable tray coupled with the housing and having a plurality of pill receptacles;
a conveyor assembly situated substantially within the housing, the conveyor assembly comprising:
a drive frame having a plurality of channels, a plurality of upper rails, and a plurality of upper guide surfaces;
a first drive assembly coupled to the drive frame and comprising:
a plurality of first pill cups situated in a first row extending between the first side and second side of the housing;
a first drive belt;
a plurality of first cup couplers coupling the plurality of first pill cups to the first drive belt; and
a first motor rotatably coupled to a first drive gear engaged with the first drive belt, wherein the first motor is selectably actuated to cause the first drive belt to rotate, thereby causing at least one of the plurality of first pill cups in the first row to advance towards a first pill receptacle of the plurality of pill receptacles;
a second drive assembly coupled to the drive frame and situated in a second channel of the plurality of channels, and comprising:
a plurality of second pill cups situated in a second row extending between the first side and second side of the housing;
a second drive belt;
a plurality of second cup couplers individually coupling the plurality of second pill cups to the second drive belt; and
a second motor rotatably coupled to a second drive gear engaged with the second drive belt, wherein the second motor is selectably actuated to cause the second drive belt to rotate, thereby causing at least one of the plurality of second pill cups in the second row to advance towards a second pill receptacle of the plurality of pill receptacles;
a third drive assembly coupled to the drive frame and situated in a third channel of the plurality of channels, and comprising:
a plurality of third pill cups situated in a third row extending between the first side and second side of the housing;
a third drive belt;
a plurality of third cup couplers individually coupling the plurality of third pill cups to the third drive belt; and
a third motor rotatably coupled to a third drive gear engaged with the third drive belt, wherein the third motor is selectably actuated to cause the third drive belt to rotate, thereby causing at least one of the plurality of third pill cups in the third row of pill cups to advance towards a third pill receptacle of the plurality of pill receptacles;
a fourth drive assembly coupled to the drive frame and situated in a fourth channel of the plurality of channels, and comprising:
a plurality of fourth pill cups situated in a fourth row extending between the first side and second side of the housing;
a fourth drive belt;
a plurality of fourth cup couplers individually coupling the plurality of fourth pill cups to the fourth drive belt; and
a fourth motor rotatably coupled to a fourth drive gear engaged with the fourth drive belt, wherein the fourth motor is selectably actuated to cause the fourth drive belt to rotate, thereby causing at least one of the plurality of fourth pill cups in the fourth row to advance towards a fourth pill receptacle of the plurality of pill receptacles; and
a processor-based control system electrically coupled with the first drive assembly, second drive assembly, third drive assembly, and fourth drive assembly, for receiving a user input and selectably actuating the first motor, the second motor, the third motor, or the fourth motor based at least in part on a time of day.
